(19) United States
(12) Patent Application Publication
(10) Pub. No.: US 2017/0206633 A1
(43) Pub. Date: Jul. 20, 2017

(54) METHOD AND APPARATUS FOR UP-SCALING AN IMAGE

(71) Applicant: THOMSON LICENSING, Issy les Moulineaux (FR)

(72) Inventors: Dirk GANDOLPH, Ronnenberg (DE); Jordi SALVADOR MARCOS, Hamburg (DE); Wolfram PUTZKE-ROEMING, HILDESHEIM (DE); Axel KOCHALE, Springe (DE)

(21) Appl. No.: 15/324,762

(22) PCT Filed: Jul. 1, 2015
(86) PCT No.: PCT/EP2015/064974

§ 371 Date: Jan. 9, 2017

(30) Foreign Application Priority Data
Jul. 10, 2014 (EP) 14306131.5

(51) Int. Cl. G06T 3/40; G06T 5/50

(52) U.S. Cl. CPC G06T 3/4053; G06T 5/50

(57) ABSTRACT

A method and an apparatus (20) for up-scaling an input image (12) are described, wherein a cross-scale self-similarity matching using superpixels is employed to obtain substitutes for missing details in an up-scaled image. The apparatus (20) comprises a superpixel vector generator (7) configured to generate (10) consistent superpixels for the input image (12) and one or more auxiliary input images (I1, I3) and to generate (11) superpixel test vectors based on the consistent superpixels. A matching block (5) performs a cross-scale self-similarity matching (12) across the input image (12) and the one or more auxiliary input images (I1, I3) using the superpixel test vectors. Finally, an output image generator (22) generates (13) an up-scaled output image (O2) using results of the cross-scale self-similarity matching (12).

### FIELD

The present principles relate to a method and an apparatus for up-scaling an image. More specifically, a method and an apparatus for up-scaling an image are described, which make use of superpixels and auxiliary images for enhancing the up-scaling quality.

### BACKGROUND

The technology of super-resolution is currently pushed by a plurality of applications. For example, the HDTV image format successors, such as UHDTV with its 2k and 4k variants, could benefit from super-resolution as the already existing video content has to be up-scaled to fit into the larger displays. Light field cameras taking multiple view images with relatively small resolutions each, do likewise require an intelligent up-scaling to provide picture qualities which can compete with state of the art system cameras and DSLR cameras (DSLR: Digital Single Lens Reflex). A third application is video compression, where a low resolution image or video stream can be decoded and enhanced by an additional super-resolution enhancement layer. This enhancement layer is additionally embedded within the compressed data and serves to supplement the prior via super-resolution up-scaled image or video.

The idea described herein is based on a technique exploiting image inherent self-similarities as proposed by G. Freedman et al. in: “Image and video upscaling from local self-examples”, ACM Transactions on Graphics, Vol. 30 (2011), pp. 12:1-12:11. While this fundamental paper was limited to still images, subsequent work incorporated multiple images to handle video up-scaling, as discussed within a paper by J. M. Salvador et al.: “Patch-based spatio-temporal super-resolution for video with non-rigid motion”, Journal of Image Communication, Vol. 28 (2013), pp. 483-493.

Unfortunately, any method for up-scaling of images is accompanied by distressing quality losses.

Over the last decade superpixel algorithms have become a broadly accepted and applied method for image segmentation, providing a reduction in complexity for subsequent processing tasks. Superpixel segmentation provides the advantage of switching from a rigid structure of the pixel grid of an image to a semantic description defining objects in the image, which explains its popularity in image processing and computer vision algorithms.

Research on superpixel algorithms began with a processing intensive feature grouping method proposed by X. Ren et al. in: “Learning a classification model for segmentation”, IEEE International Conference on Computer Vision (ICCV) 2003, pp. 10-17. Subsequently, more efficient solutions for superpixel generation were proposed, such as the simple linear iterative clustering (SLIC) method introduced by R. Achanta et al. in: “SLIC superpixels compared to state-of-the-art superpixel methods”, IEEE Transactions on Pattern Analysis and Machine Intelligence, Vol. 34 (2012), pp. 2274-2282. While earlier solutions focused on still images, later developments aimed at application of superpixels to video, which require their temporal consistency. In M. Reso et al.: “Temporally Consistent Superpixels”, International Conference on Computer Vision (ICCV), 2013, pp. 385-392, an approach achieving this demand is described, which provides traceable superpixels within video sequences.

### SUMMARY

It is an object to describe an improved solution for up-scaling of an image, which allows achieving reduced quality losses.

According to one embodiment, a method for up-scaling an input image, wherein a cross-scale self-similarity matching using superpixels is employed to obtain substitutes for missing details in an up-scaled image, comprises:
generating consistent superpixels for the input image and one or more auxiliary input images;
generating superpixel test vectors based on the consistent superpixels;
performing a cross-scale self-similarity matching across the input image and the one or more auxiliary input images using the superpixel test vectors; and
generating an up-scaled output image using results of the cross-scale self-similarity matching.

Accordingly, a computer readable storage medium has stored therein instructions enabling up-scaling an input image, wherein a cross-scale self-similarity matching using superpixels is employed to obtain substitutes for missing details in an up-scaled image. The instructions, when executed by a computer, cause the computer to:
generate consistent superpixels for the input image and one or more auxiliary input images;
generate superpixel test vectors based on the consistent superpixels;
perform a cross-scale self-similarity matching across the input image and the one or more auxiliary input images using the superpixel test vectors; and
generate an up-scaled output image using results of the cross-scale self-similarity matching.

Also, in one embodiment an apparatus configured to up-scale an input image, wherein a cross-scale self-similarity matching using superpixels is employed to obtain substitutes for missing details in an up-scaled image, comprises:
a superpixel vector generator configured to generate consistent superpixels for the input image and one or more auxiliary input images and to generate superpixel test vectors based on the consistent superpixels;
a matching block configured to perform a cross-scale self-similarity matching across the input image and the one or more auxiliary input images using the superpixel test vectors; and
an output image generator configured to generate an up-scaled output image using results of the cross-scale self-similarity matching.

In another embodiment, an apparatus configured to up-scale an input image, wherein a cross-scale self-similarity matching using superpixels is employed to obtain substitutes for missing details in an up-scaled image, comprises a processing device and a memory device having stored therein instructions, which, when executed by the processing device, cause the apparatus to:
generate consistent superpixels for the input image and one or more auxiliary input images;
generate superpixel test vectors based on the consistent superpixels;
perform a cross-scale self-similarity matching across the input image and the one or more auxiliary input images using the superpixel test vectors; and
generate an up-scaled output image using results of the cross-scale self-similarity matching.

The proposed super-resolution method tracks captured objects by analyzing generated temporal or multi-view consistent superpixels. The awareness about objects in the image material and of their whereabouts in time or in different views is transferred into advanced search strategies for finding relevant multi-image cross-scale self-similarities. By incorporating the plurality of significant self-similarities found for different temporal phases or different views a better suited super-resolution enhancement signal is generated, resulting in an improved picture quality. The proposed super-resolution approach provides an improved image quality, which can be measured in peak signal-to-noise ratio via the comparison against ground truth data. In addition, subjective testing confirms the visual improvements for the resulting picture quality, which is useful, as peak signal-to-noise ratio measures are not necessarily consistent with human visual perception.

The super-resolution approach works on multiple images, which might represent an image sequence in time (e.g. a video), a multi-view shot (e.g. Light Field camera image holding multiple angles), or even a temporal sequence of multi-view shots. These applications are interchangeable, which means that multi-view images and temporal images can be treated as equivalents.

In one embodiment, the solution comprises:
up-sampling the input image to obtain a high resolution, low frequency image;
determining match locations between the input image and the high resolution, low frequency image, and between the one or more auxiliary input images and the high resolution, low frequency image;
composing a high resolution, high frequency composed image from the input image and the one or more auxiliary input images using the match locations; and
combining the high resolution, low frequency image and the high resolution, high frequency composed image into a high resolution up-scaled output image.

Typically, the up-sampled image has distressing quality losses due to the missing details. However, these missing details are substituted using image blocks from the input image and the one or more auxiliary input images. While these images will only contain a limited number of suitable image blocks, these blocks are generally more relevant, i.e. fitting better.

In one embodiment, the input images are band split into low resolution, low frequency images and low resolution, high frequency images, wherein the low resolution, low frequency images are used for the cross-scale self-similarity matching and the low resolution, high frequency images are used for generating the up-scaled output image. In this way an efficient analysis of self-similarity is ensured and the necessary high-frequency details for the up-scaled output image can be reliably obtained.

In one embodiment, an image block for generating the up-scaled output image is generated by performing at least one of selecting a single image block defined by a best match of the cross-scale self-similarity matching, generating a linear combination of all or a subset of blocks defined by matches of the cross-scale self-similarity matching, and generating an average across all image blocks defined by matches of the cross-scale self-similarity matching. While the former two solutions require less processing power, the latter solution shows the best results for the peak signal-to-noise ratio.

For a better understanding the solution shall now be explained in more detail in the following description with reference to the figures. It is understood that the solution is not limited to this exemplary embodiment and that specified features can also expediently be combined and/or modified without departing from the scope of the present solution as defined in the appended claims.

### BRIEF DESCRIPTION OF THE DRAWINGS

FIG. 1 shows a block-diagram of a known super-resolution algorithm;

FIG. 2 shows an extended and more compact version of the block diagram of FIG. 1;

FIG. 3 depicts a super-resolution multi-image self-similarity matching using superpixels;

FIG. 4 illustrates a linear combination of image blocks, where combination weights are determined via linear regression;

FIG. 5 shows an example of an image before segmentation into superpixels;

FIG. 6 shows the image of FIG. 5 after segmentation into superpixels;

FIG. 7 shows an example of a single temporally consistent superpixel being tracked over a period of three images;

FIG. 8 shows average peak signal-to-noise ratios obtained for different up-scaling algorithms;

FIG. 9 shows average structural similarity values obtained for different up-scaling algorithms;

FIG. 10 depicts a method according to an embodiment for up-scaling an image;

FIG. 11 schematically depicts a first embodiment of an apparatus configured to perform a method for up-scaling an image; and

FIG. 12 schematically illustrates a second embodiment of an apparatus configured to perform a method for up-scaling an image.

### DETAILED DESCRIPTION OF PREFERRED EMBODIMENTS

In the following the solution is explained with a focus on temporal image sequences, e.g. images of a video sequence. However, the described approach is likewise applicable to spatially related images, e.g. multi-view images.

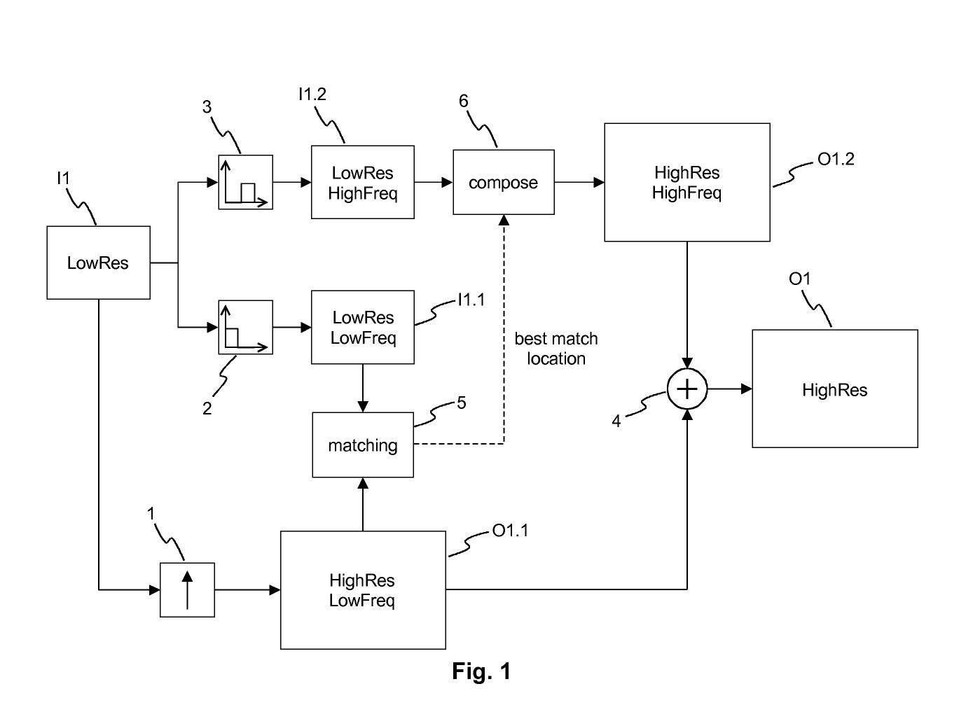

The approach described in the following is based on the super-resolution algorithm by G. Freedman et al., as shown by the block-diagram in FIG. 1. Of course, the general idea is likewise applicable to other super-resolution algorithms. For simplicity the block diagram describes a solution working for single images only, while the proposed approach provides a solution for multiple images. All corresponding necessary extensions are explained later in a separate block diagram.

In FIG. 1 a low resolution input image I1 is processed by three different filters: an up-sampling filter 1 generating a low frequency, high resolution image O1.1, a low-pass filter 2 generating a low frequency, low resolution image I1.1, and a high-pass filter 3 generating a high frequency, low resolution image 11.2.

Usually the up-sampled image O1.1 has distressing quality losses due to the missing details caused by a bi-cubic or alternatively a more complex up-sampling. In the following steps a substitute for these missing details is generated by exploiting the inherent cross-scale self-similarity of natural objects. The process of generating the missing details results in a high frequency, high resolution image O1.2, which can be combined with the low frequency, high resolution image O1.1 in a processing block 4 to generate the final high-resolution output image 12.

The cross-scale self-similarities are detected by a matching process block 5. This matching process block 5 searches the appropriate matches within the low resolution image I1.1 for all pixels in the high resolution image O1.1. State of the art for the matching process is to search within fixed extensions of a rectangular search window. The matching process block 5 generates best match locations for all pixels in O1.1 pointing to I1.1. These best match locations are transferred to a composition block 6, which copies the indicated blocks from the high frequency, low resolution image I1.2 into the high frequency, high resolution image O1.2.

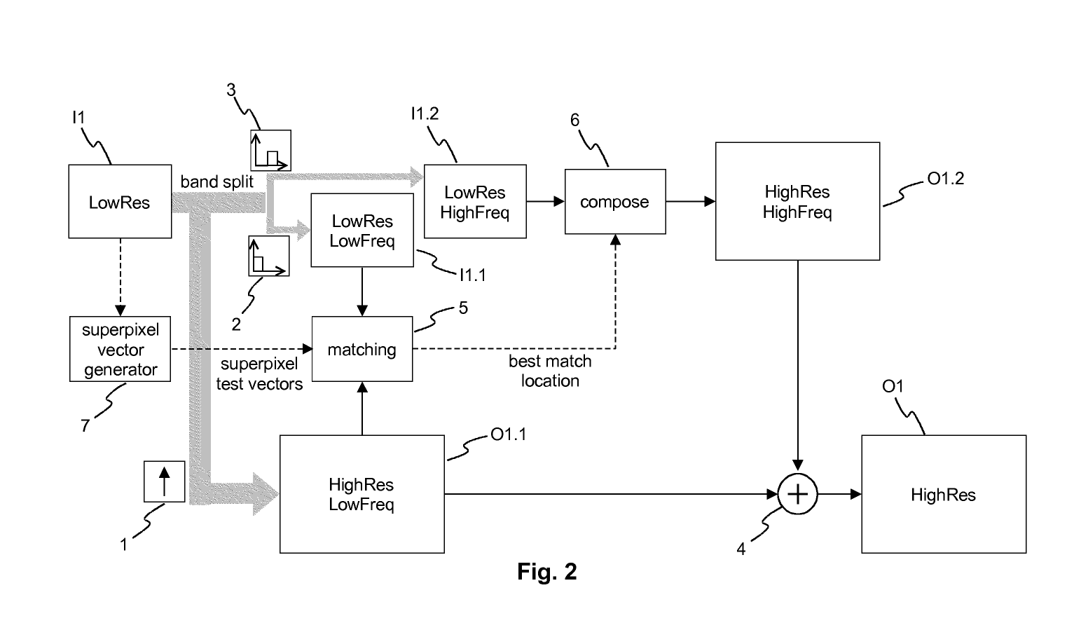

The block diagram in FIG. 2 shows a more compact version of the block diagram of FIG. 1, which is extended by an advanced matching technique. The additional block in FIG. 2 is a superpixel vector generator 7, which processes the input image I1 for calculating superpixels and selects test vectors used for the matching block 5. The superpixel test vector generation substitutes the rigid rectangular search window used in FIG. 1.

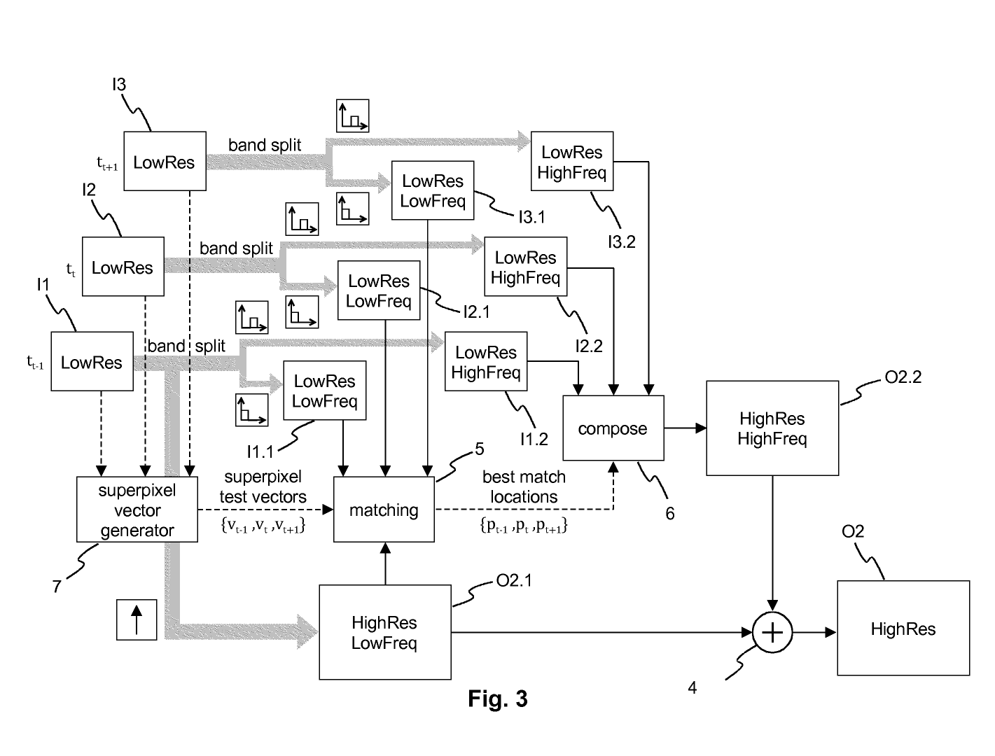

The block diagram in FIG. 3 explains a further extension of the superpixel vector generation, namely a super-resolution multi-image self-similarity matching using superpixels. As its predecessor in FIG. 2 the block diagram of FIG. 3 is aware of the objects in the image material. The idea is that the objects are tracked over multiple images, which serve to generate test vectors for the matching across multiple input images in the vector generator block 7. In FIG. 3 the number of input images is three, but this number is not mandatory and can be increased or reduced by including or excluding images located in future or past direction. Similarly, a multi-view application can include or exclude further views/angles, or a temporal sequence of multi-view images can include or exclude further views/angles and/or temporally succeeding or preceding images.

The example given in FIG. 3 shows the proposed method executed for image 12 at time tₜ for creating the output image O2 also at the time tₜ. The input images I1 and 13 at the times tₜ₋₁ and tₜ₊₁ are additional sources to find relevant cross-scale self-similarities for the output image O2.

The matching block 5 receives the superpixel test vectors for all input images, which in this example are {vₜ₋₁, vₜ, vₜ₊₁}, and generates best match locations for all pixels in O2.1 pointing to I1.1, I2.1, and I3.1, respectively. In the figure this is indicated by {pₜ₋₁, pₜ, pₜ₊₁} representing three complete sets of best match locations. Usually the dimension of a set equals the number of input images. The composition block 6 combines the indicated blocks from I1.2, I2.2, and I3.2 and copies the combination result into the high frequency, high resolution image O2.2.

In the following a more detailed description of the vector generator block 7 and the composition block 6 is given.

The multi-image superpixel vector generator block 7 generates the superpixel test vector set {vₜ₋₁, vₜ, vₜ₊₁} by performing the following steps:

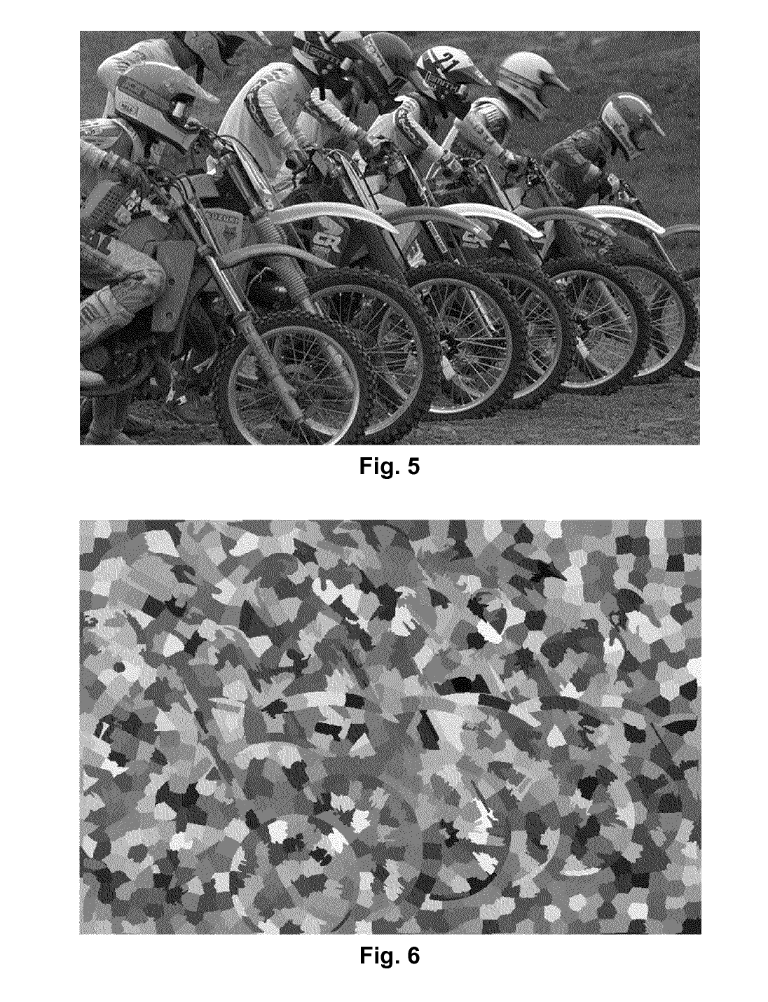

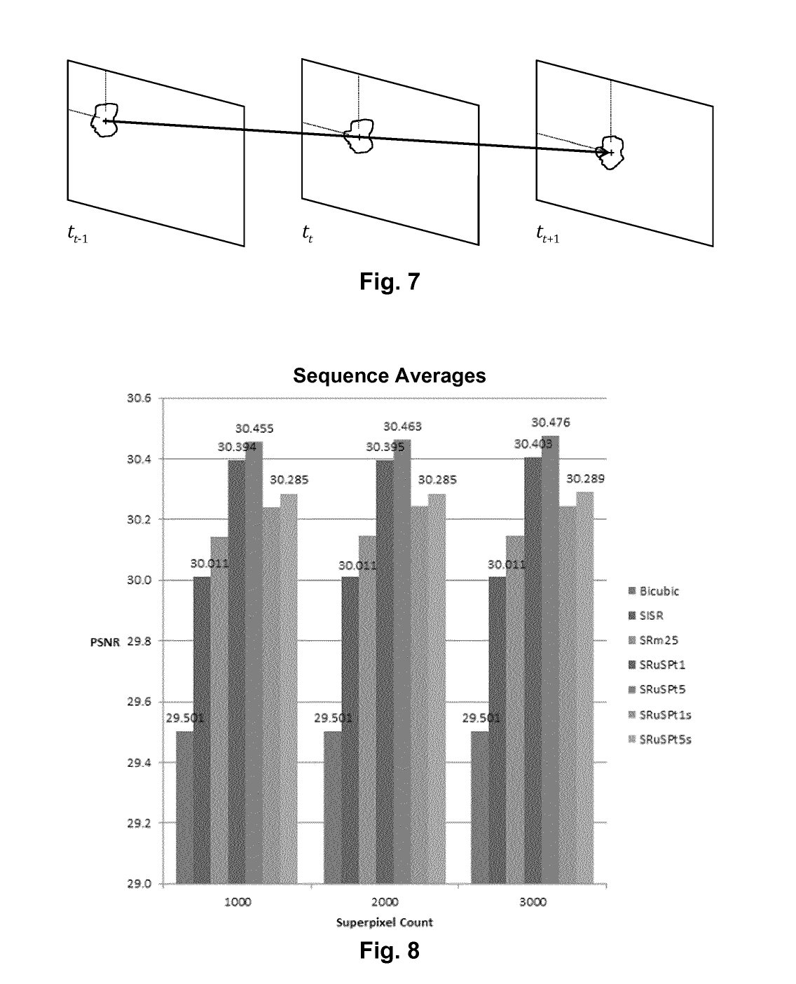

STEP 1: Generating consistent superpixels {SPₜ₋₁(m), SPₜ(n), SPₜ₊₁(r)}, where the indices {m,n,r} run over all superpixels in the images. The term temporally consistent can be substituted with multi-view consistent for multi-view applications. An approach for generating temporally consistent superpixels is described in M. Reso et al.: “Temporally Consistent Superpixels”, International Conference on Computer Vision (ICCV), 2013, pp. 385-392. FIG. 5 shows an example of an image being segmented into superpixel areas as depicted in FIG. 6, where each superpixel is represented using a different grey value. FIG. 6 is called a superpixel label map. FIG. 7 shows an example of a single temporally consistent superpixel being tracked over the period of three images, where the superpixels follow a moving object in the video scene depicted in the images at the times tₜ₋₁, tₜ, and tₜ₊₁.

STEP 2: Generating search vectors {sₜ₋₁(ζ), sₜ(ζ), sₜ₊₁(ζ)} separately for all superpixel images, where the index ζ runs across all image positions. One approach for generating such search vectors is described, for example, in co-pending European Patent Application EP14306130.

STEP 3: Generating object related pixel assignments for all superpixels

Sdₜ→SPₜ₊₁ SPₜ→SPₜ₋₁

and

SPₜ→SPₜ₊₂ SPₜ→SPₜ₋₂,

. . . → . . . . . . → . . .

where the number of relations depends on the number of input images. One approach for generating such object related pixel assignments is described, for example, in co-pending European Patent Application EP14306126. In the example in FIG. 3 only the very first lines are used.

STEP 4: The final superpixel test vectors {vₜ₋₁, vₜ, vₜ₊₁} are determined by applying the pixel assignments found in STEP 3. For the example in FIG. 3 each separate superpixel SPₜ(n)≡SP_{t,n} in the image at the time tₜ has a pixel individual assignment to SPₜ₋₁(m)≡SP_{t-t,m} and a pixel individual assignment to SPₜ₊₁(r)≡SP_{t+1,r}, which can be expressed by p_{t,n}(i)→p_{t-1,m}(j) and p_{t,n}(i)→p_{t+,r}(k), with i ∈ {1, . . . I}, j ∈ {1, . . . J}, and k ∈ {1, . . . K}. In other words, for each pixel p_{t,n}(i) located in an origin superpixel SP_{t,n} in the image at the time tₜ corresponding pixels p_{t-1,m}(j) and p_{t+1,r}(k) are required, being located within the superpixels SP_{t-1,m} in the image at the time tₜ₋₁ and SP_{t+1,r} in the image at the time tₜ₊₁. I is the number of pixels contained in SP_{t,n}, J the number of pixels contained in SP_{t-1,m} and K the number of pixels contained in SP_{t+1,r}. In general the numbers of pixels I, J, and K are different. Therefore, the resulting pixel mappings can be one-to-many, one-to-one, many-to-one, and a combination of them.

The test vectors vₜ need no assignments, as they can be taken directly, i.e. vₜ(ζ)=sₜ(ζ). The test vectors vₜ₋₁ and vₜ₊₁ use the assignments according to vₜ₋₁(ζ)=sₜ₋₁ (p_{t,n}(ζ)→pₜ₋₁ₘ(ζ)) and vₜ₊₁(ζ)=sₜ₊₁(p_{t,n}(ζ)→p_{t+1,r}(ζ)), respectively. A larger number of input images is treated accordingly.

The block combination performed by the composition block 6 can be implemented, for example, using one of the following approaches:

a) Selection of a single block only defined by the very best match, i.e. the best among all best matches found.

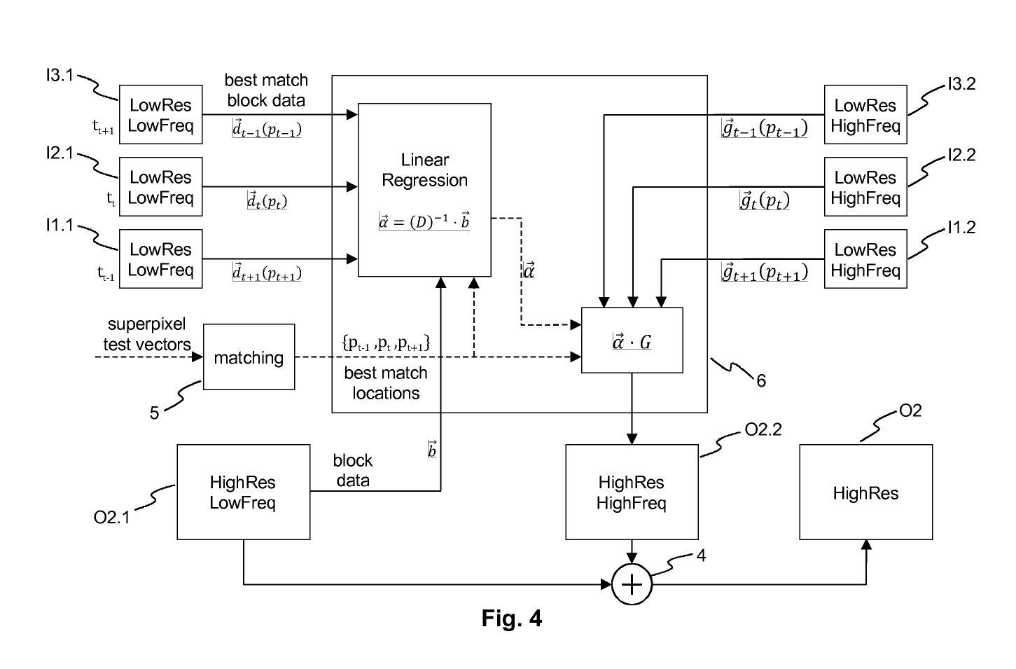

b) A linear combination of all or a subset of the blocks, where the weights (linear factors) are determined via linear regression, as shown in FIG. 4.

c) Generating the average across all best matches found. This approach is preferable, as it shows the best results for the PSNR (Peak Signal-to-Noise Ratio).

FIG. 4 shows the linear regression approach for composing the high frequency, high resolution image O2.2 executed within the composition block 6. The linear regression is processed for each pixel position ζ in O2.1 individually by taking the best match locations {pₜ₋₁, pₜ, pₜ₊₁}, fetching the best match block data {\vec{d}ₜ₋₁(pₜ₋₁), \vec{d}ₜ(pₜ, \vec{d}ₜ₊₁(pₜ₊₁)} and the target block b by forming the regression equation

$${α}^{} = {( \begin{matrix}{d}_{t , 1} & {d}_{t - 1 , 1} & {d}_{t + 1 , 1} & … \\ {d}_{t , 2} & {d}_{t - 1 , 2} & {d}_{t + 1 , 2} & … \\ … & … & … & … \\ {d}_{t , q} & {d}_{t - 1 , q} & {d}_{t + 1 , q} & …\end{matrix} )}^{- 1} \cdot ( \begin{matrix}{b}_{1} \\ {b}_{2} \\ … \\ {b}_{q}\end{matrix} ) or {α}^{} = {( D )}^{- 1} \cdot {b}^{} ,$$

where q is the number of pixels in the matching block. This equation is solvable if the count of input images is less or equal to the number of pixels in the matching block. In case that the count of input images is higher it is proposed to reduce the horizontal dimension of matrix D by selecting the best matching blocks only, i.e. those blocks with the minimum distance measures.

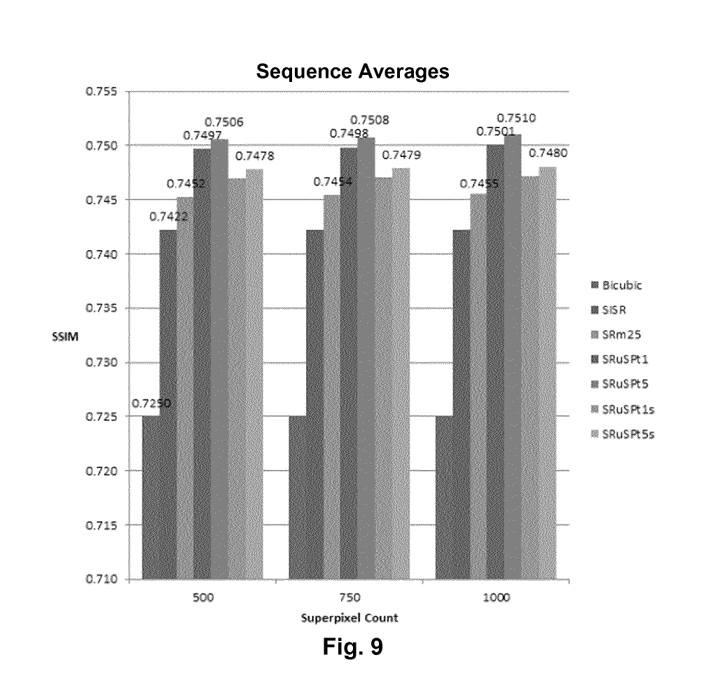

The two diagrams in FIGS. 8 and 9 show the average PSNR and SSIM (Structural SIMilarity) analyzed over a sequence of 64 images by comparing the up-scaled images against ground truth data. Shown are the comparisons between the following algorithms:

bicubic: Up-scaling via bi-cubic interpolation.

SISR: Single Image Super Resolution, the matching process searches within fixed extensions of a rectangular search window.

SRm25: Single image Super Resolution using a vector based self-similarity matching. The search vector length is 25.

SRuSPt1: Multi-image self-similarity matching using superpixels across three images {tₜ₋₁, tₜ, tₜ₊₁}, i.e. one previous and one future image, by averaging as described above in item c).

SRuSPt5: Multi-image self-similarity matching using superpixels across eleven images {tₜ₋₅, . . . , tₜ₋₁, tₜ, tₜ₊₁, . . . , tₜ₊₅}, i.e. five previous and five future images, by averaging as described above in item c).

SRuSPt1s: Multi-image self-similarity matching using superpixels across three images {tₜ₋₁, tₜ, tₜ₊₁}, i.e. one previous and one future image, but selecting the best matching block as described above in item a).

SRuSPt5s: Multi-image self-similarity matching using superpixels across eleven images {tₜ₋₅, . . . , tₜ₋₁, tₜ, tₜ₊₁, . . . , tₜ₊₅}, i.e. five previous and five future images, but selecting the best matching block as described above in item a).

The two diagrams show that all methods using superpixel controlled self-similarity matching are superior to the matching within a fixed search area. They also reveal that an increase of input images creates an improvement for the PSNR and SSIM values. Finally, it can be seen that the SRuSPt5 algorithm analyzing eleven input images creates superior PSNR and SSIM values.

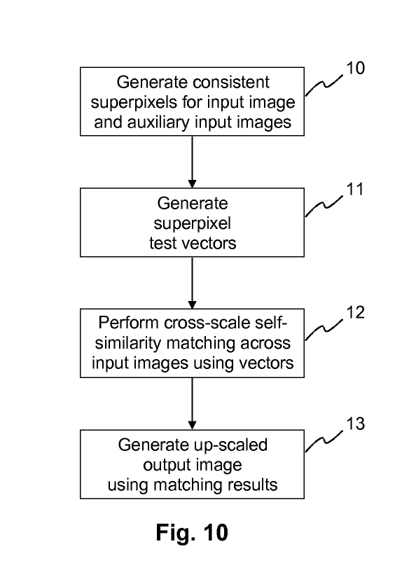

FIG. 10 schematically illustrates one embodiment of a method for up-scaling an image, wherein a cross-scale self-similarity matching using superpixels is employed to obtain substitutes for missing details in an up-scaled image. In a first step consistent superpixels are generated 10 for the input image I2 and one or more auxiliary input images I1, I3.

Based on these consistent superpixels superpixel test vectors are then generated 11. Using the superpixel test vectors a cross-scale self-similarity matching 12 is performed across the input image I2 and the one or more auxiliary input images I1, I3. Finally, an up-scaled output image O2 is generated 13 using results of the cross-scale self-similarity matching 12.

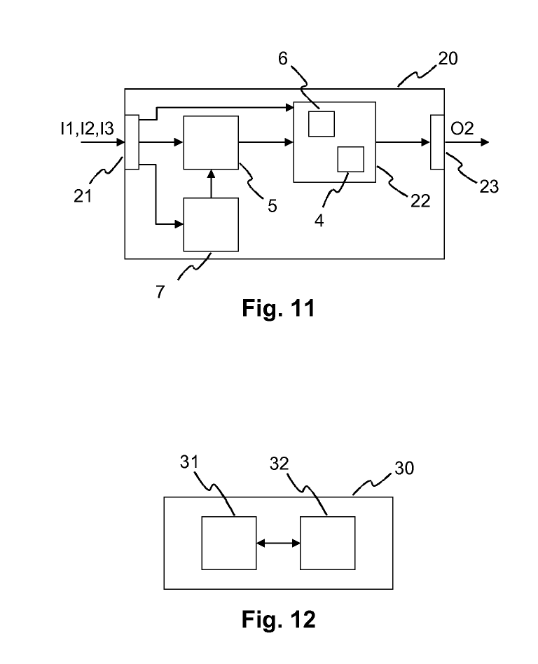

FIG. 11 depicts one embodiment of an apparatus 20 for up-scaling an input image I2. The apparatus 20 employs a cross-scale self-similarity matching using superpixels to obtain substitutes for missing details in an up-scaled image. To this end the apparatus 20 comprises an input 21 for receiving an input image I2 to be up-scaled and one or more auxiliary input images I1, I3. A superpixel vector generator 7 generates 10 consistent superpixels for the input image I2 and one or more auxiliary input images I1, I3, and further generates 11 superpixel test vectors based on the consistent superpixels. Of course, these two functions may likewise be performed by separate processing blocks. A matching block 5 performs a cross-scale self-similarity matching 12 across the input image I2 and the one or more auxiliary input images I1, I3 using the superpixel test vectors. An output image generator 22 generates 13 an up-scaled output image O2 using results of the cross-scale self-similarity matching 12. In one embodiment, the output image generator 22 comprises the composition block 6 and a processing block 4 as described further above. The resulting output image O2 is made available at an output 23 and/or stored on a local storage. The superpixel vector generator 7, the matching block 5, and the output image generator 22 are either implemented as dedicated hardware or as software running on a processor. They may also be partially or fully combined in a single unit. Also, the input 21 and the output 23 may be combined into a single bi-directional interface.

Another embodiment of an apparatus 30 configured to perform the method for up-scaling an image is schematically illustrated in FIG. 12. The apparatus 30 comprises a processing device 31 and a memory device 32 storing instructions that, when executed, cause the apparatus to perform steps according to one of the described methods.

For example, the processing device 31 can be a processor adapted to perform the steps according to one of the described methods. In an embodiment said adaptation comprises that the processor is configured, e.g. programmed, to perform steps according to one of the described methods.

1. A method for up-scaling an input image, wherein a cross-scale self-similarity matching using superpixels is employed to obtain substitutes for missing details in an up-scaled image, said superpixels corresponding to objects of said input image defined by a semantic description, wherein the method comprises:
generating superpixels for the input image and one or more auxiliary input images, said superpixels being consistent between said input image and said one or more auxiliary input images;
generating superpixel test vectors based on the consistent superpixels, said superpixel test vectors being adapted to search appropriate cross-scale self-similarity matches in the input image and the one or more auxiliary input images;
performing a cross-scale self-similarity matching across the input image and the one or more auxiliary input images using the superpixel test vectors; and
generating an up-scaled output image using results of the cross-scale self-similarity matching.

2. The method according to claim 1, the method comprising:
up-sampling the input image to obtain a high resolution, low frequency image;
determining match locations between the input image and the high resolution, low frequency image, and between the one or more auxiliary input images and the high resolution, low frequency image;
composing a high resolution, high frequency composed image from the input image and the one or more auxiliary input images using the match locations; and
combining the high resolution, low frequency image and the high resolution, high frequency composed image into a high resolution up-scaled output image

3. The method according to claim 1, wherein the input image and the one or more auxiliary input images are successive images of a sequence of images or multi-view images of a scene.

4. The method according to claim 1, wherein the input images are band split into low resolution, low frequency images and low resolution, high frequency images, wherein the low resolution, low frequency images are used for the cross-scale self-similarity matching and the low resolution, high frequency images are used for generating the up-scaled output image.

5. The method according to claim 1, wherein an image block for generating the up-scaled output image is generated by performing at least one of selecting a single image block defined by a best match of the cross-scale self-similarity matching, generating a linear combination of all or a subset of blocks defined by matches of the cross-scale self-similarity matching, and generating an average across all image blocks defined by matches of the cross-scale self-similarity matching.

6. A computer readable storage medium having stored therein instructions enabling up-scaling an input image, wherein a cross-scale self-similarity matching using superpixels is employed to obtain substitutes for missing details in an up-scaled image, said superpixels corresponding to objects of said input image defined by a semantic description, wherein the instructions, when executed by a computer, cause the computer to:
generate superpixels for the input image and one or more auxiliary input images, said superpixels being consistent between said input image and said one or more auxiliary input images;
generate superpixel test vectors based on the consistent superpixels, said superpixel test vectors being adapted to search appropriate cross-scale self-similarity matches in the input image and the one or more auxiliary input images;
perform a cross-scale self-similarity matching across the input image and the one or more auxiliary input images using the superpixel test vectors; and
generate an up-scaled output image using results of the cross-scale self-similarity matching.

7. An apparatus configured to up-scale an input image, wherein a cross-scale self-similarity matching using superpixels is employed to obtain substitutes for missing details in an up-scaled image, said superpixels corresponding to objects of said input image defined by a semantic description, the apparatus comprising:
a superpixel vector generator configured to generate consistent superpixels for the input image and one or more auxiliary input images, said superpixels being consistent between said input image and said one or more auxiliary input images, and to generate superpixel test vectors based on the consistent superpixels, said superpixel test vectors being adapted to search appropriate cross-scale self-similarity matches in the input image and the one or more auxiliary input images;
a matching block configured to perform a cross-scale self-similarity matching across the input image and the one or more auxiliary input images using the superpixel test vectors; and
an output image generator configured to generate an up-scaled output image using results of the cross-scale self-similarity matching.

8. An apparatus configured to up-scale an input image, wherein a cross-scale self-similarity matching using superpixels is employed to obtain substitutes for missing details in an up-scaled image, said superpixels corresponding to objects of said input image defined by a semantic description, the apparatus comprising a processing device and a memory device having stored therein instructions, which, when executed by the processing device, cause the apparatus to:
generate consistent superpixels for the input image and one or more auxiliary input images, said superpixels being consistent between said input image and said one or more auxiliary input images;
generate superpixel test vectors based on the consistent superpixels, said superpixel test vectors being adapted to search appropriate cross-scale self-similarity matches in the input image and the one or more auxiliary input images;
perform a cross-scale self-similarity matching across the input image and the one or more auxiliary input images using the superpixel test vectors; and
generate an up-scaled output image using results of the cross-scale self-similarity matching.
